(19) United States
(12) Patent Application Publication
(10) Pub. No.: US 2024/0364399 A1
(43) Pub. Date: Oct. 31, 2024

(54) SYSTEM AND METHOD FACILITATING IMPROVED QUALITY OF SERVICE BY A SCHEDULER IN A NETWORK

(71) Applicant: Radisys India Private Limited, Bangalore (IN)

(72) Inventors: Saptarshi CHAUDHURI, Bengaluru (IN); Shekar NETHI, Hyderabad (IN); Chandrasekaran MOHANDOSS, Chennai (IN)

(73) Assignee: Radisys India Private Limited, Bangalore (IN)

(21) Appl. No.: 18/246,693

(22) PCT Filed: Dec. 28, 2022
(86) PCT No.: PCT/IB2022/062834

§ 371 Date: Mar. 27, 2023

(30) Foreign Application Priority Data
Dec. 29, 2021 (IN) 202141061400

(51) Int. Cl. H04B 7/06; H04L 41/5009; H04W 72/12; H04W 72/231; H04W 72/566

(52) U.S. Cl. CPC H04B 7/0626; H04B 7/0632; H04L 41/5009; H04W 72/12; H04W 72/231; H04W 72/566

(57) ABSTRACT

The present invention provides a robust and effective solution to an entity or an organization by enabling implementation of a plurality of aspects such as resource block allocation maximization, system key performance indicator (KPI) and fairness by an efficient quality of service in a scheduler. The method facilitates in executing a plurality of policy steps that can enable in achieving the efficient QoS scheduler functioning.

### RESERVATION OF RIGHTS

A portion of the disclosure of this patent document contains material, which is subject to intellectual property rights such as, but are not limited to, copyright, design, trademark, IC layout design, and/or trade dress protection, belonging to Radisys or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to communications networks. More particularly, the present disclosure relates to improved resource allocation mechanism through enhanced quality of service (QOS) of a scheduler.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

The fifth generation (5G) technology is expected to fundamentally transform the role that telecommunications technology plays in the industry and society at large. Thus, the 5G wireless communication system is expected to support a broad range of newly emerging applications on top of the regular cellular mobile broadband services. These applications or services may be categorized into enhanced mobile broadband and ultra-reliable low latency communication systems. Services may be utilized by a user for a video conference, a television broadcast, and a video on-demand (simultaneous streaming) application using different types of multimedia services.

In summary, the gNB (base station) provides a 5G New Radio's user plane and control plane protocol terminations towards a user equipment (UE). The gNB's are connected by means of the NG interfaces, more specifically to the (AMF) Access and Mobility Management Function by means of the NG2 interface (NG-Control) interface and to the User Plane Function (UPF) by means of the NG3 (NG-User) interface.

The communication between the base station and the user equipment happens through the wireless interface using the protocol stacks. One of the main protocol stack is the physical (PHY) layer. Whenever, the user traffic data from the Data Network needs to be sent to the user equipment, it passes through the User Plane Function (UPF), the gNB and reaches the user equipment in the downlink direction and vice-versa for the uplink direction.

In the existing systems and methods, the downlink as well as the uplink transmission happens through the Cyclic Prefix based Orthogonal Frequency Division Multiplexing (CP-OFDM), which is part of the PHY layer. So, in order to perform the transmission, the CP-OFDM uses the Physical Resource Block (PRB) to send both the user's traffic data over PDSCH as well as user's signalling data over PDCCH. Further, the Physical Resource Block (PRB) is built using Resource Elements. For the downlink direction, the upper layer stacks assign the number of Resource Elements to be used for the PDCCH and PDSCH processing. In addition, there are four important concepts that have been defined for, with respect to resources and the way the resources are being grouped to be provided for PDCCH. These concepts are; (a) Resource Element that is a smallest unit of the resource grid made up of one subcarrier in frequency domain and one OFDM symbol in time domain. (b) Resource Element Group (REG) that is made up of one resource block (12 Resource Element in frequency domain) and one OFDM symbol in time domain. (c) Control Channel Element (CCE) that is made up of multiple REGs where the number of REG bundles varies within a CCE. (d) Aggregation Level indicates how many CCEs are allocated for a PDCCH.

In order to transmit a Physical-layer processing for Physical control channel (PDCCH) and Physical-layer processing for Physical shared channel (PDSCH) information using the CCEs in the downlink direction, existing systems use a bandwidth part (BWP) method. The BWP method enables more flexibility in how allocated CCEs resources are assigned in each carrier. The BWP method enables multiplexing of different information of PDCCH and PDSCH, thus enabling better utilization and adaptation of operator spectrum and UE's battery consumption. 5G NR's maximum carrier bandwidth is up to 100 MHz in frequency range 1 (FR1: 450 MHz to 6 GHZ), or up to 400 MHZ in frequency range 2 (FR2: 24.25 GHz to 52.6 GHZ) that can be aggregated with a maximum bandwidth of 800 MHZ.

Further, for a gNB/base station system, there could be multiple candidates defined for each of the aggregation levels. Thus, using the multiple candidates per aggregation levels and for getting the number of control channel elements (CCEs) per aggregation level. the gNB system calculates the total number of CCEs per requirement. Hence, the total number of CCEs shall be finally used for the Control Resource Set (CORESET) calculation. Further, the CORESET comprises of multiples REGs in frequency domain and ‘1 or 2 or 3’ OFDM symbols in time domain.

In 5G new radio (NR) system the task of a scheduler is to allocate time and frequency resources to all users. There are several metrics which a scheduler can employ in prioritizing users. Multiple throughput metrics can be used for the scheduler. One metric is based on the logarithm of the achieved data rate, the best channel quality indicator (CQI) metric and the like. For providing high throughput and reducing complexity, the scheduling is decomposed into time domain scheduling where multiple UEs are selected and passed on to the frequency domain scheduler. The best channel quality indicator (CQI) metric can be used for allocating the resource block groups (RBGs) to the user equipments (UEs). The time domain scheduler aims at providing a target bit rate to all users and shares the additional resources according to the proportional fair policy. Multi-step prioritization can be followed. For example, blind equal throughput or proportional fair metric can be used. Among the selected users, existing metrics like proportional fair combined with QoS fairness, packet delay budget (PDB) and PER may be utilized.

The patent document WO2017175039A1 discloses a method and apparatus for end-to-end quality of service/quality of experience (QoS/QoE) management in 5G systems. Various methods are provided in the document for providing dynamic and adaptive QoS and QoE management of U-Plane traffic while implementing user and application specific differentiation and maximizing system resource utilization. A system comprised of a policy server and enforcement point(s). The policy server may be a logical entity configured for storing a plurality of QoS/QoE policies. Each of the plurality of policies identifying a user, service vertical, application, context, and associated QoE targets. The policy server may be further configured to provide one or more QoS/QoE policies to the enforcement point(s). Further, the QoS/QoE policies may be configured to provide QoE targets, for example, at a high abstraction level and/or at an application session level.

However, certain QoS policies may not be followed as expected because of the dynamic changes in QoS from the enforcement points. This method fails disclose about the resource utilization, fairness among UEs and system KPIs etc.

The patent document WO2017176248A1 discloses a context aware quality of service/quality of experience QoS/QoE policy provisioning and adaptation in 5G systems. The method includes detecting, by an enforcement point, an initiation of a session for an application. The method includes requesting, by the enforcement point, a first level quality of experience policy for the detected session. Further the method includes, receiving, from a policy server, the first level quality of experience policy for the detected session. The method includes deriving, based on the first level quality of experience policy, a second level quality of experience target and/or a quality of service target for the detected session. The method includes enforcing, by the enforcement point, the second level quality of experience target and/or the quality of service target on the detected session.

However, the drawback is that this method describes about the enforcement point where it derives the child QoS/QoE policy from the parent QoS/QoE policies and enforces the same. Certain QoS policies may not be followed as expected because of the dynamic changes in QoS from the enforcement points. This method is fails to disclose about the resource utilization, fairness among UEs and system KPIs etc.

The patent document US20120196566A1 discloses a method and apparatus for providing QoS-based service in wireless communication system. The method includes providing a Mobile Station (MS) with quality of service (QOS) plan indicating a price policy for a QoS acceleration service having a higher QoS than a default QoS designated for a user of the MS in response to a request from the MS. Further, the method includes providing the MS with an authorized token and a QoS quota based on a selected QoS plan in response to a purchase request of the MS. Also, the method includes providing the MS with service contents selected by the user through a radio bearer for the QoS acceleration service. Additionally, the method includes, notifying the MS, if a usage of the QoS acceleration service reaches a threshold, of an impending expiration of the QoS acceleration service, and notifying the MS of the expiration of the QoS acceleration service.

However, this method is describing about the QoS acceleration service based on the QoS price plan requested by the mobile station. According to the QoS pricing plan, the mobile station is prioritized to satisfy the QoS acceleration service. This method fails to describe the QoS policies of users who have not opted for QoS acceleration service.

The patent document WO2018006249A1 discloses a QoS control method in 5G communication system and related device. The QoS control method in a 5G communication system and a related device for providing more refined and more flexible QoS control for a 5G mobile communication network. The method comprises a terminal user equipment (UE) determining, according to a QoS rule, a radio bearer mapped to an uplink data packet and a QoS class identification corresponding to the uplink data packet. The method further includes, carrying by the UE the QoS class identification in the uplink data packet and sending by the UE the uplink data packet through the radio bearer. But the drawback is that this method describes a terminal UE to map the uplink data packet based on the QoS identifier while transmitting the uplink data packet along with the QoS identifier. These QoS policies fail to disclose anything about the scheduling functions, prioritization based on the traffic, resource utilization, fairness among UEs and system KPIs etc.

The patent document US20070121542A1 discloses a Quality-of-service (QoS)-aware scheduling for uplink transmission on dedicated channels. It also provides a method for scheduling in a mobile communication system where data of priority flows is transmitted by mobile terminals through dedicated uplink channels to a base station. Each mobile terminal transmits at least data of one priority flow through one of the dedicated uplink channels. Moreover, the invention relates to a base station for scheduling priority flows transmitted by mobile terminals through the dedicated uplink channels to the base station. Further, a mobile terminal transmitting at least data of one priority flow through a dedicated uplink channel to a base station is provided. In order to optimize base station controlled-scheduling functions in a mobile communication system, the document proposes to provide the scheduling base station with QoS requirements of individual priority flows transmitted through an uplink dedicated channel. Further, the method includes the adaptation of the mobile terminals to indicate the priority flows of data to be transmitted to the base stations for scheduling.

However, the method describes about the scheduling functions controlled based on the quality of service (QOS) requirements of each traffic flow in uplink direction. This method fails to disclose about the resource utilization, fairness among user equipments (UEs) and system key performance indicators (KPIs) etc.

Thus, there is a need for a system and a method that resolves many of the implementation aspects such as resource block (RB) allocation maximization, system KPIs and fairness while providing an efficient quality of service (QOS) scheduler functioning.

### OBJECTS OF THE PRESENT DISCLOSURE

Some of the objects of the present disclosure, which at least one embodiment herein satisfies are as listed herein below.

It is an object of the present disclosure to provide a system and a method that considers multiple system level parameters (e.g., connected users, system KPIs, Feedbacks) along with estimated user channel condition distribution in order to determine users for the DL/UL transmission.

It is an object of the present disclosure to provide a system and a method that computes the resource estimation for each user through a policy resource block allocation.

It is an object of the present disclosure to provide a system and a method that considers system KPIs such as throughput, spectral efficiency, and fairness index.

It is an object of the present disclosure to provide a system and a method that is scalable for multiple cell deployment i.e., macro to small cell deployment.

### SUMMARY

This section is provided to introduce certain objects and aspects of the present disclosure in a simplified form that are further described below in the detailed description. This summary is not intended to identify the key features or the scope of the claimed subject matter.

In an aspect, the communication system may include one or more computing devices communicatively coupled to a base station. The base station may be configured to transmit information from a data network configured in the communication system. The base station may further include one or more processors, coupled to a memory with instructions to be executed. The processor may transmit, one or more primary signals to the one or more computing devices, wherein the one or more primary signals are indicative of a channel status information from the base station. Further, the processor may receive, one or more feedback signals from the one or more computing devices based on the one or more primary signals, wherein the one or more feedback signals are indicative of one or more parameters associated with the one or more computing devices. Also, the processor may extract, a first set of attributes from the received one or more feedback signals, wherein the first set of attributes are indicative of a channel quality indicator (CQI) received from the one or more computing devices. Additionally, the processor may extract, a second set of attributes from the received one or more primary signals, wherein the second set of attributes are indicative of one or more logical parameters of the processor. Further, the processor may extract, a third set of attributes, based on the second set of attributes, wherein the third set of attributes are indicative of one or more policies adapted by the processor for scheduling the one or more computing devices. Based on the first set of attributes, the second set of attributes and the third set of attributes, the processor may generate a scheduling priority for the one or more computing devices using one or more techniques. Further, the processor may transmit, a downlink control information (DCI) to each of the one or more computing devices using one or more resource blocks. The processor may allocate, the scheduling priority to the one or more computing devices (102) using the one or more resource blocks containing the downlink control information (DCI).

In an embodiment, the one or more parameters may comprise a rank, a layer indicator and a precoder validity received from the one or more computing devices.

In an embodiment, the one or more techniques may comprise any or a combination of a proportional fair (PF), a modified largest weighted delay (M-LWDF), an exp rule, and a log rule.

In an embodiment, the processor may use one or more formats associated with the downlink control information (DCI) and generate one or more time offsets during the allocation of the scheduling priority.

In an embodiment, the processor may include a cell throughput optimization, a delay sensitivity, a fairness and a minimization of packet drop as the one or more logical parameters of the processor.

In an embodiment, the processor may generate one or more quality of service (QoS) parameters based on the one or more logical parameters.

In an embodiment, the processor may prioritize the one or more computing devices using the one or more quality of service (QOS) parameters while generating the scheduling priority for the one or more computing devices.

In an embodiment, the processor may categorize the one or more quality of service (QOS) parameters into a guaranteed flow bit rate (GFBR) and a maximum flow bit rate (MFBR). The processor may also classify the one or more computing devices into a guaranteed bit rate (GBR), a delay-critical guaranteed bit rate (GBR), and a non-guaranteed bit rate (non-GBR) applications.

In an embodiment, the one or more policies adapted by the processor may include prioritization of a voice over new radio (VoNR) and the guaranteed bit rate (GBR) over the non-guaranteed bit rate (non-GBR) applications associated with the one or more computing devices.

In an embodiment, the one or more policies adapted by the processor may include estimation of the one or more resource blocks and a number of layers associated with the one or more computing devices based on the received one or more feedback signals.

In an embodiment, the one or more policies adapted by the processor may include prioritization of one or more re-transmissions, the voice over new radio (VoNR), the guaranteed bit rate (GBR) traffic apart from the voice over new radio (VoNR) and the non-guaranteed bit rate (non-GBR) in an increasing order.

In an embodiment, the one or more policies adapted by the processor may include application of one or more resource management formulations for sorting the GBR and the non-GBR applications.

In an embodiment, the one or more policies adapted by the processor may include a maximization of the one or more resource blocks.

In an embodiment, the one or more policies adapted by the processor may include a penalty based non-GBR allocation for the maximization of the one or more resource blocks.

In an embodiment, the one or more policies adapted by the processor may further include one or more key performance indicators (KPI's) such as a throughput, a cell edge throughput, a fairness index. The one or more policies may also include optimization of the scheduling priority for the one or more computing devices to achieve the one or more key performance indicators (KPI's).

In an aspect, the method for facilitating improved quality of service by a scheduler may include transmitting, by a processor one or more primary signals to one or more computing devices. The one or more primary signals may be indicative of channel status information from the base station. Further, the one or more computing devices may be configured in a communication system and communicatively coupled to the base station, while the base station may be configured to transmit information from a data network. The method may also include, receiving, by the processor, one or more feedback signals from the one or more computing devices based on the one or more primary signals. The one or more feedback signals may be indicative of one or more parameters associated with the one or more computing devices. Further, the method may include extracting by the processor, a first set of attributes from the received one or more feedback signals. The first set of attributes may be indicative of a channel quality index (CQI) received from the one or more computing devices. The method may include extracting by the processor, a second set of attributes from the received one or more primary signals. The second set of attributes may be indicative of one or more logical parameters of the processor. Additionally, the method may include extracting by the processor, a third set of attributes, based on the second set of attributes. The third set of attributes may be indicative of one or more policies adapted by the processor for scheduling the one or more computing devices. Also, the method may include generating, by the processor, based on the first set of attributes, the second set of attributes and the third set of attributes, a scheduling priority for the one or more computing devices using one or more techniques. Further, the method may include transmitting, by the processor, a downlink control information (DCI) to each of the one or more computing devices using one or more resource blocks. Also, the method may include allocating, by the processor, the scheduling priority to the one or more computing devices using the one or more resource blocks containing the downlink control information (DCI).

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an exemplary network architecture of the system (100), in accordance with an embodiment of the present disclosure.

FIG. 2 illustrates an exemplary representation (200) of system (100) for QoS scheduling in a network, in accordance with an embodiment of the present disclosure.

FIG. 3. illustrates an exemplary system architecture (300) for the QoS scheduler, in accordance with an embodiment of the present disclosure.

FIG. 4 illustrates an exemplary representation (400) of the functional blocks of the QoS scheduler, in accordance with an embodiment of the present disclosure.

FIG. 5 illustrates an exemplary representation (500) of scalability of the solution for macro and small cell deployment, in accordance with an embodiment of the present disclosure.

FIG. 6 illustrates a flow diagram (600) of the resource allocation procedure, in accordance with an embodiment of the present disclosure.

FIG. 7 illustrates a flow diagram (700) of the proposed method, in accordance with an embodiment of the present disclosure.

FIGS. 8A-8C illustrate exemplary representations (800) of the proposed QoS scheduler, in accordance with an embodiment of the present disclosure.

FIG. 9 illustrates an exemplary computer system (900) that can be utilized in accordance with embodiments of the present disclosure.

The foregoing shall be more apparent from the following more detailed description of the invention.

### BRIEF DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

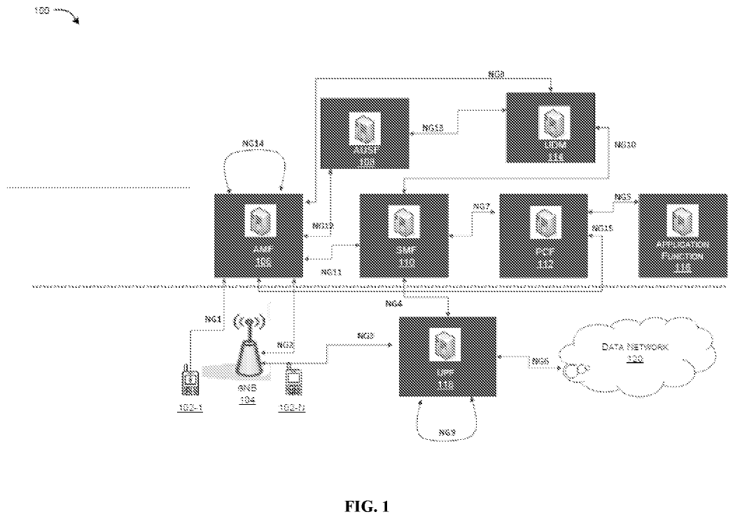

FIG. 1 illustrates an exemplary network architecture of the system 100), in accordance with an embodiment of the present disclosure. As illustrated, a 5G base station (104) (also referred to as base station (104) may provide a 5G New Radio's user plane (122) and control plane (124) protocol towards one or more computing devices (102) (hereinafter referred as computing devices (102)). The base station may be connected by means of a network gateway (NG) interfaces (NG1, NG2 . . . . NG15) to the 5GC, more specifically to an Access and Mobility Management Function (AMF 106) by means of the NG2 interface (NG-Control) interface and to a User Plane Function (118) (UPF 118) by means of the NG3 (NG-User) interface. The network architecture may further include an authentication server function (AUSF 108), a user data management (UDM 114), a session management function (SMF 110), a policy control function (PCF 112) and an application function unit (116).

The communication between the base station (104) and the computing devices (102) in the communication system (100) may happen through the wireless interface using the protocol stacks. One of the main protocol stack may be the Physical layer (also referred to as PHY). Whenever, a user traffic data from a data network (120) needs to be sent to the computing devices (102), the user traffic data may pass through the UPF (118) and the base station (104) and reach the computing devices (102) in a downlink direction and vice-versa for an uplink direction. In order to schedule the user traffic data in the downlink direction, at least two main PHY layer functionalities may be considered (a) Physical-layer processing for physical downlink shared channel (PDSCH) (b) Physical-layer processing for physical downlink control channel (PDCCH). In an exemplary embodiment, a user's traffic data may be sent through the PDSCH but a user's signalling data of the user's traffic data with respect to (i) Modulation (ii) Coding rate (iii) Size of the user's traffic data (iv) Transmission beam identification (v) Bandwidth part (vi) Physical Resource Block and the like may be sent via PDCCH. The downlink as well as the uplink transmission may happen through a Cyclic Prefix based Orthogonal Frequency Division Multiplexing (CP-OFDM) but not limited to it, which is part of the PHY layer. So, in order to do the transmission, the CP-OFDM may use the Physical Resource Block (PRB) to send both the user's traffic data over PDSCH as well as user's signalling data over PDCCH.

In an exemplary embodiment, the one or more resource blocks may be built using the resource elements. For the downlink direction, the upper layer stacks may assign the number of resource elements to be used for the PDCCH and PDSCH processing. There may be at least four important concepts defined with respect to resources and the way the resources are being group to be given for PDCCH. These concepts may include (a) resource element: It is the smallest unit of the resource grid made up of one subcarrier in frequency domain and one OFDM symbol in time domain. (b) resource element group (REG): One REG is made up of one resource block (12 resource element in frequency domain) and one OFDM symbol in time domain. (c) Control Channel Element (CCE). A CCE is made up multiple REGs where the number REG bundles within a CCE may vary. (d) Aggregation Level: The Aggregation Level may indicate the number of CCEs allocated for a PDCCH. The Aggregation Level and the number of allocated CCE as given in Table 1:

| Aggregation Level | Number of CCEs |
|---|---|
| 1 | 1 |
| 2 | 2 |
| 4 | 4 |
| 8 | 8 |
| 16 | 16 |

In an exemplary embodiment, the base station (104) may receive user traffic data from a plurality of candidates/computing devices (102), identify relevant candidates for each aggregation level based on service and content for effective radio resource usage with respect to the control channel elements (CCEs). The relevant candidates may be identified by enabling a predefined set of system parameters for candidate calculation. Depending on a geographical deployment area, the processor can cause the base station to accept the predefined system parameters of the configuration, self-generate operational parameter values for candidate calculation and dynamically generate operational parameter values for the candidate calculation for various aggregation levels.

For example, the access and mobility management function, AMF (106) may hosts the following main functions such as the non-access stratum (NAS) signalling termination, non-access stratum (NAS) signalling security, AS Security control, Inter CN node signalling for mobility between 3GPP access networks. Additionally, the AMF (106) may host Idle mode user equipment (UE) reachability (including control and execution of paging retransmission), registration area management, support of intra-system and inter-system mobility, access authentication, access authorization including check of roaming rights. Further, the AMF (106) may host mobility management control (subscription and policies), support of network slicing.

The user plane function, UPF (118) may host the following main functions such as an anchor point for Intra-/Inter-radio access technology (RAT) mobility (when applicable), external protocol data unit (PDU) session point of interconnect to data network, packet routing and forwarding, packet inspection and user plane part of policy rule enforcement. Additionally the UPF (118) may host traffic usage reporting, uplink classifier to support routing traffic flows to a data network, and branching point to support multi-homed PDU session. The UPF (118) may host quality of service (QOS) handling for user plane, e.g. packet filtering, gating, uplink/downlink (UL/DL) rate enforcement, uplink traffic verification, downlink packet buffering and downlink data notification triggering.

The sessions management function SMF (110) may host the following main functions such as session management, user equipment IP address allocation and management, and selection. The SMF (110) may further host traffic steering at UPF (118) to route traffic to proper destination, control part of policy enforcement and QoS, downlink data notification.

The policy control function PCF (112) may host the following main functions such as network slicing, roaming and mobility management. The PCF (112) may access subscription information for policy decisions taken by the unified data repository (UDR). Further, the PCF (112) may support the new 5G QoS policy and charging control functions.

The authentication server function AUSF (108) may perform the authentication function of 4G home subscriber server (HSS) and implement the extensible authentication protocol (EAP).

The unified data manager UDM (114) may perform parts of the 4G HSS function. The UDM (114) may include generation of authentication and key agreement (AKA) credentials. Also, the UDM (114) may perform user identification, access authorization, and subscription management.

The application function AF (116) may include application influence on traffic routing, accessing network exposure function and interaction with the policy framework for policy control.

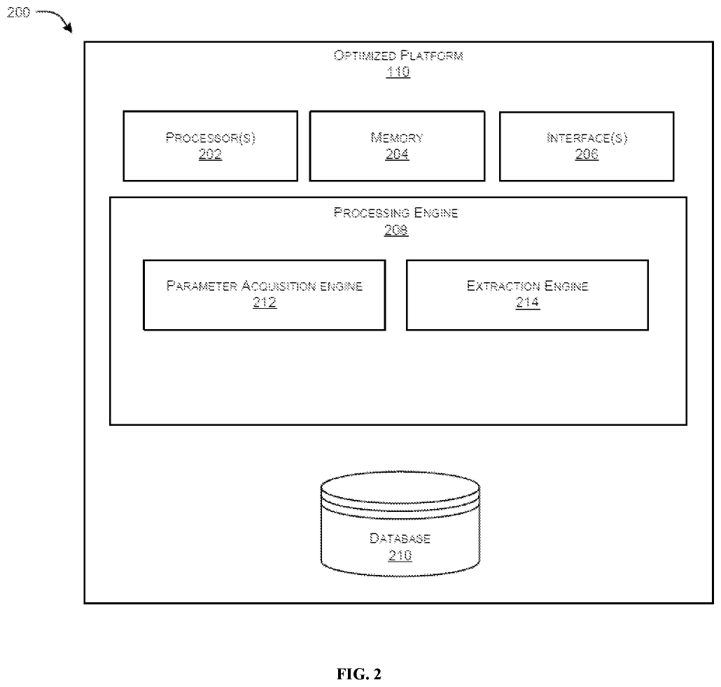

FIG. 2 illustrates an exemplary representation (200) of the system (100), in accordance with an embodiment of the present disclosure.

In an aspect, the system (100) may comprise one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (100). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as RAM, or non-volatile memory such as EPROM, flash memory, and the like.

In an embodiment, the system (100) may include an interface(s) (206). The interface(s) (206) may comprise a variety of interfaces, for example, interfaces for data input and output devices, referred to as I/O devices, storage devices, and the like. The interface(s) (206) may facilitate communication of the system (100). The interface(s) (206) may also provide a communication pathway for one or more components of the system (100). Examples of such components include, but are not limited to, processing engine(s) (208) and a database (210).

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (100) may comprise the machine-readable storage medium storing the instructions and the processing resource to execute the instructions, or the machine-readable storage medium may be separate but accessible to the system (100) and the processing resource. In other examples, the processing engine(s) (208) may be implemented by electronic circuitry.

Further, the communication system/system (100) may include computing devices (102) configured in the communication system (100) and communicatively coupled to a base station (104) in the communication system (100). The base station (104) may be configured to transmit information from a data network (120) configured in the communication system (100). The base station may include one or more processors (202), coupled to a memory (204) with instructions, when executed causes the processor (202) to transmit, one or more primary signals to the computing devices (102). The processing engine (208) may include one or more engines selected from any of a signal acquisition engine (212), and an extraction engine (214).

In an embodiment, the base station (104) may transmit one or more primary signals indicative of a channel status to the computing devices (102). The signal acquisition engine (212) may be configured to receive, one or more feedback signals from the computing devices (102) based on the transmitted one or more primary signals. The one or more feedback signals may be indicative of one or more parameters associated with the one or more computing devices (102).

In an embodiment, the extraction engine (214) may extract, a first set of attributes from the received one or more feedback signals. The first set of attributes may be indicative of a channel quality indicator (CQI) received from the computing devices (102) and store it in the database (210). The extraction engine (214) may extract, a second set of attributes from the received one or more primary signals and store it in the database (210). The second set of attributes may be indicative of one or more logical parameters of the processor (202). The logical parameters may include a cell throughput optimization, a delay sensitivity, a fairness and a minimization of packet drop.

The parameters may comprise a rank, a layer indicator and a precoder validity received from the one or more computing devices (102). The extraction engine (214) mayextract, a third set of attributes, based on the second set of attributes and store it in the database (210). The third set of attributes may be indicative of one or more policies adapted by the processor (202) for scheduling the computing devices (102). The one or more policies adapted by the processor (202) may comprise prioritization of a voice over new radio (VONR) and the guaranteed bit rate (GBR) over the non-guaranteed bit rate (non-GBR) applications associated with the one or more computing devices (102). Additionally, the one or more policies adapted by the processor (202) may further comprise prioritization of one or more re-transmissions, the voice over new radio (VoNR), the guaranteed bit rate (GBR) traffic apart from the voice over new radio (VoNR) and the non-guaranteed bit rate (non-GBR) in an increasing order. Further, the one or more policies adapted by the processor (202) may comprise application of one or more resource management formulations for sorting the GBR and the non-GBR applications. Based on the first set of attributes, the second set of attributes and the third set of attributes, the processor (202) may generate a scheduling priority for the one or more computing devices (102) using one or more techniques. The one or more techniques may comprise any or a combination of a proportional fair (PF), a modified largest weighted delay (M-LWDF), an exp rule, and a log rule. The processor (202) may transmit, a downlink control information (DCI) to each of the computing devices (102) using one or more resource blocks. Further, the processor (202) may allocate, the scheduling priority to the computing devices (102) using the one or more resource blocks containing the downlink control information (DCI).

Also, the processor (202) may be configured to use one or more formats associated with the downlink control information (DCI) and generate one or more time offsets during the allocation of the scheduling priority. Further, the processor (202) may be configured to generate one or more quality of service (QOS) parameters based on the one or more logical parameters. Further, the processor (202) may be configured to prioritize the one or more computing devices (102) using the one or more quality of service (QOS) parameters while generating the scheduling priority for the one or more computing devices (102). Additionally, the processor (202) may be configured to categorize the one or more quality of service (Qos) parameters into a guaranteed bit flow rate (GFBR) and a maximum flow bit rate (MFBR). The processor (202) may further classify the one or more computing devices (102) into a guaranteed bit rate (GBR), a delay-critical guaranteed bit rate (GBR), and a non-guaranteed bit rate (non-GBR) applications.

Further, the one or more policies adapted by the processor (202) may comprise estimation of the one or more resource blocks and a number of layers associated with the one or more computing devices (102) based on the received one or more feedback signals. Also, the one or more policies adapted by the processor (202) may comprise maximization of the one or more resource blocks and further comprise a penalty based non-GBR allocation for the maximization of the one or more resource blocks. Additionally, the one or more policies adapted by the processor (202) may comprise one or more key performance indicators (KPI's) such as a throughput, a cell edge throughput, a fairness index. The processor (202) may also provide optimization of the scheduling priority for the one or more computing devices (102) to achieve the one or more key performance indicators (KPI's).

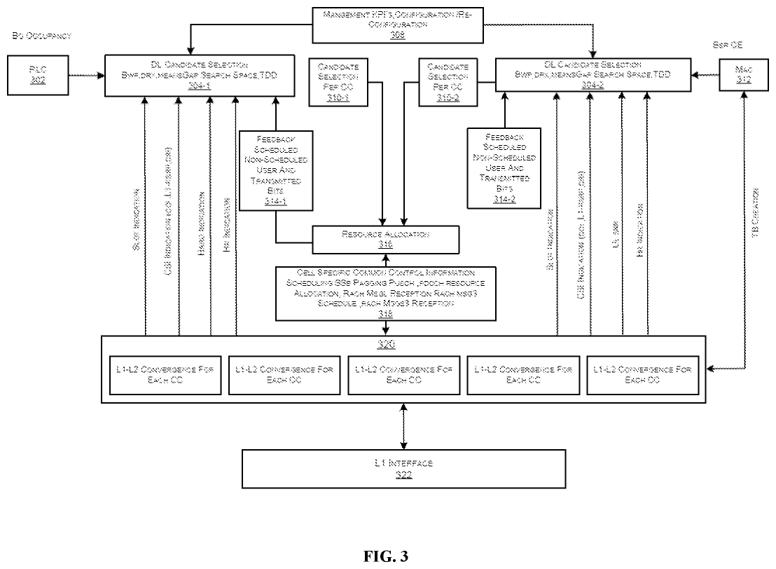

FIG. 3 represents the system architecture (300) for the QoS scheduler (300) (also referred to as the system (300) hereinafter or previously known as the communication system (100)) may include a plurality of core modules of the QoS scheduler (300) such as a candidate selection module (304) that can be a downlink (DL) selection module (304-1) or an uplink (UL) Candidate Selection module (304-2), a resource allocation (RA) module (316), an L1-L2 convergence layer (320) and one or more interface such as L1, RLC, and the like (322). In an embodiment, the processor (202) may include a cell throughput optimization, a delay sensitivity, a fairness and a minimization of packet drop as the one or more logical parameters. The processor (202) may be configured to generate one or more quality of service (QoS) parameters based on the one or more logical parameters.

In an exemplary embodiment, the system (300) (previously system (100)) may consider a plurality of system level parameters such as connected users, system key performance indicators (KPIs), feedbacks and the like along with estimated user channel condition distribution in order to determine users for the down link (DL) and uplink (UL) transmission considering system key performance indicators (KPIs).

In an embodiment, the one or more policies adapted by the processor (202) may comprise estimation of the one or more resource blocks and a number of layers associated with the computing devices (102) based on the received one or more feedback signals.

In an exemplary embodiment, the system (300) may compute resource block (RB) estimation required for each user. The system (300) may maximize resource allocation based on a predefined resource block (RB) allocation policy. The system (300) may be configured to be scalable for multiple cell deployment such as macro to small cell deployment and the like.

In an embodiment, the processor (202) may prioritize the computing devices (102) using the one or more quality of service (QOS) parameters while generating the scheduling priority for the computing devices (102).

In an exemplary embodiment, the core task performed by the candidate section (CS) module (304) of the system (300) may be to formulate a list of prioritized computing devices (102) and estimate the resources required. The prioritization can be based on one or more utility functions used to model a plurality of throughput requirements, a plurality of delay requirements, and packet error rate but not limited to the like. The formulated list of prioritized computing devices (102) can be then sent to the resource allocation (RA) module (216) for resource allocation.

In an exemplary embodiment, the system (300) may read information about a Channel State Information (CSI). For example, the CSI can be a CSI-ReportConfigReporting Settings, and CSI-ResourceConfig Resource Settings. Each Reporting SettingCSI-ReportConfig can be associated with a single downlink bandwidth part (BWP) (indicated by higher layer parameter bwp-Id) given in the associated CSI-Resource Config for channel measurement. It may contain the parameter(s) for one CSI reporting band, codebook configuration including codebook subset restriction, time-domain behaviour, and frequency granularity for channel quality indicator (CQI) and precoding matrix indicator (PMI). It may further contain measurement restriction configurations, and CSI-related quantities to be reported by the computing devices (102). The CSI-related quantities may include the layer indicator (LI), L1-reference signal received power signal (L1-RSRP), the channel resource indicator (CRI), and the synchronizing signal block resource indicator (SSBRI) Type I single panel.

In an exemplary embodiment, the Algorithm module (306) may include inputs such as but not limited to block error rate (BLER) targets, closed loop signal to interference plus noise ratio (SINR target), 5QI values and fairness constraints. The scheduler/system 300 may operate on a per-cell basis or Component Carrier (CC) and the algorithm module (306) may be applied to determine Candidate Selection (CS), Resource Allocation (RA) while taking into account Proportional Fair (PF), Modified Largest Weighted Delay First (M-LWDF), EXP rule, LOG rule or their variants for CS to take care of the application requirements. The algorithm (306) module can provide the best channel quality indicator (CQI) or proportional fair (PF) for resource allocation (RA) in resource blocks (RBs).

In an exemplary embodiment, the Outcome module (308) may include one or more parameters that are used for further processing can be enumerated as below:
Number of computing devices (102) in the current transmission time interval (TTI) as well as the selected computing devices (102)
Hybrid automatic repeat request (HARQ) process selected for the computing devices (102).
Applications to be served in the current transmission time interval (TTI).
Physical downlink shared channel/physical uplink shared channel (PDSCH/PUSCH) allocation
I-modulation coding scheme (I-MCS) and number of resource blocks (RBs) for the computing devices (102).
Demodulation reference signal (DM-RS) ports

In an embodiment, the processor (202) may categorize the one or more quality of service (QOS) parameters into a guaranteed bit flow rate (GFBR) and a maximum flow bit rate (MFBR). Further, the processor (202) may classify the computing devices (102) into a guaranteed bit rate (GBR), a delay-critical guaranteed bit rate (GBR), and a non-guaranteed bit rate (non-GBR) applications.

In an exemplary embodiment, packets may be classified and marked using a QoS Flow Identifier (QFI). The 5G QoS flows can be mapped in the Access Network (AN) to Data Radio Bearers (DRBs) unlike 4G LTE where mapping is one to one between evolved packet core (EPC) and radio bearers. It supports following quality of service (QOS) flow types.
GBR QOS flow, requiring guaranteed flow bit rate
Non-GBR QoS flow, that does not require guaranteed flow bit rate.

In an embodiment, the QoS flow may be characterized by
A QoS profile provided by the SMF to the Access Network (AN) through the access and mobility function (AMF) over the N2 reference point or preconfigured in the AN.
One or more QoS rules and optionally quality of service (QOS) flow level QoS parameters.
One or more uplink (UL) and downlink (DL) packet detection rules (PDRs).

In an embodiment, a QoS Flow may be either ‘GBR’ or ‘Non-GBR’ depending on its QoS profile. The QoS profile of a QoS Flow can be sent to the Access Network (AN). The QoS may contain QoS parameters as below.
5G QOS Identifier (5QI)
Allocation and Retention Priority (ARP)

In an embodiment, for each GBR QoS Flow only, the QoS profile shall include the QoS parameters:
Guaranteed Flow Bit Rate (GFBR)-Uplink (UL) and Downlink (DL).
Maximum Flow Bit Rate (MFBR)-Uplink (UL) and Downlink (DL)

In an embodiment, the processor (202) may be configured to include a cell throughput optimizationα, a delay sensitivityβ, a fairnessy and a minimization of packet drop δas the one or more logical parameters. The performance of different applications may be characterized by their respective utility functions. The parameters α, β, γ, δ control the relative priorities of the logical channels (LCs) and their scheduling metrics. The QoS defined in terms of the 5G QoS Identifier (5QI) may be further characterized by:
Resource Type
Priority Level
Packet Delay Budget
Packet Error Rate
Default Maximum Data Burst Volume
Averaging Window (for guaranteed bit rate (GBR) and delay-critical guaranteed bit rate (GBR) resource type only).
Resource Type: GBR, Delay-critical GBR, and Non-GBR

In an exemplary embodiment, the averaging window and maximum data burst volume may be the control parameters to determine the window over which guaranteed service is provided.

In an exemplary embodiment, the processor (202) may differentiate between quality of service (QOS) flow of the same computing devices (102) and service (QOS) flows from different computing devices (102). Various metrics may be used to differentiate the QoS Flows.

In an exemplary embodiment, the resource assignment (RA) may be configured to allocate the resource blocks (RBs) to the computing devices (102) to assist the scheduler/processor (202) in allocating resource blocks for each transmission.

In a way of example and not as a limitation, resource allocation type can be determined implicitly by a downlink control information (DCI) format or by a radio resource control (RRC) Layer. It can be done implicitly when the scheduling grant is received with DCI Format 1_0, DL resource allocation type 1 is used. Indication in the DCI about resource allocation type 0 or type 1 can be done and then RRC parameter can be given resource-allocation-config with time-domain/frequency domain resource allocation. In an embodiment, there are at least two types of allocation such as Allocation Type 0 and Allocation Type 1.

In an exemplary implementation, Allocation Type 0 may provide:
Number of consecutive resource blocks (RBs) bundled into resource block group (RBG) and physical downlink shared channel (PDSCH)/physical uplink shared channel (PUSCH) allocated only in multiples of RBG.
The number of resource blocks (RBs) within are source block group (RBG) varies depending on the (BWP) size and configuration type as per Table 5.1.2.2.1-1 in 38.214.
The configuration type is determined by the resource block group-size (rbg-size) field in PDSCH-Config in a radio resource control (RRC) message.
A bitmap in DCI indicates the RBG number that carries PDSCH or PUSCH data.

In an exemplary implementation, in Allocation Type 1:
Resource allocated to one or more consecutive resource blocks (RBs).
The resource allocation area is defined by two parameters: RB_Start and Number of consecutive resource blocks (RBs) within a specific bandwidth part (BWP).
When the resource allocation is specified in DCI, RB_Start and Number of consecutive resource blocks (RBs) within the bandwidth part (BWP) is combined into a single value called Resource Indicator Value (RIV).

In an exemplary embodiment, a physical resource block (PRB) bundling may include:
a physical resource Block group (PRG) where over the frequency span of one PRG, the computing devices (102) may assume that the precoder may remain the same and use it in the channel estimation process.
physical resource Block group (PRG) size: 2, 4 or scheduled bandwidth
Wideband: computing devices (102) are not expected to be scheduled with non-contiguous physical resource block (PRBs) and the computing devices (102) may assume that the same precoding is applied to the allocated resource
Physical resource Block group (PRG) partitions the bandwidth part (BWP) I with P_{BWP}_{ᵢ}′ consecutive physical resource block (PRBs).
Same precoding to all physical resource block (PRBs) in a physical resource Block group (PRG).
Physical resource block (PRB) bundling-type

In an exemplary embodiment, the L1-L2 Convergence Layer (220) may include interfaces provided in TABLE 1 below

TABLE 1

| INTERFACE | INDICATIONS/Feedbacks/Reports |
|---|---|
| MAC→ DL SCH | Buffer status report (BSR) |
| RLC→ DL SCH | Buffer occupancy (BO) |
| L1-L2 ← CL | Sounding reference signal (SRS), SLOT, |
| | Cyclic redundancy check(CRC), Resource |
| | allocation request (RA REQ), Uplink |
| | control information (UCI) |
| RA→ SCH | Successful/Unsuccessful resource allocation |
| | (RA) feedback, |
| APP ←→ SCH | Key performance indicators (KPI's), |
| | Configuration/Re-Configuration |
| L1-L2 → CL | Transport Block Generation |

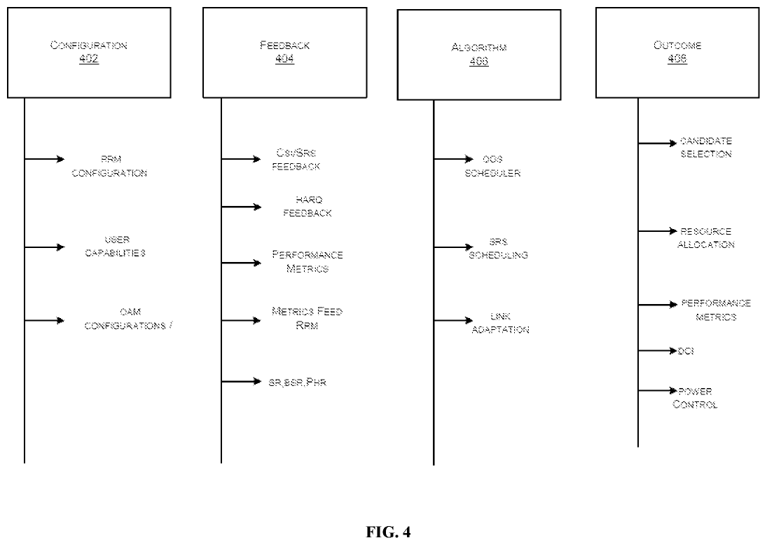

FIG. 4 illustrates an exemplary representation (400) of the functional blocks of the quality of service (QOS) scheduler (previously as the system (300)), in accordance with an embodiment of the present disclosure. As illustrated, in an aspect, the functional blocks may include configuration block (402), feedback block (404), algorithm block (406) and an outcome block (408).

In an exemplary embodiment, the configuration block (402) may include configuration as per user configuration. A cell level configuration may include system parameters and channel state information (CSI) may be Type 1 CSI and Type 2 CSI with a hybrid automatic repeat (HARQ) configuration.

In an exemplary embodiment, the feedback module (404) may be channel dependent such that inputs from the channel module determine the most appropriate modulation and coding scheme (MCS). Channel state information (CSI) and sounding reference signal (SRS) reports provide an indication to the base station (104) on how resource should be allocated to provide a certain throughput.

Further, the feedback module (404) may be device specific. Constraints on the base station (104) to adhere to the quality of service (QOS) characteristics of the device such as the amount of throughput to be delivered. The parameters are typically the QoS parameters, buffer status of the different data flows, priorities of the different data flows including the amount of data pending for retransmission.

The feedback module (404) may be cell-specific. Cell-throughput and average throughput per cell as feedback to scheduler/system (300) that can be utilized for required corrective actions.

In an exemplary embodiment, the base station (104) may have variety of connected computing devices (104). Different computing devices (104) can have different channel status information (CSI) estimation algorithms based on its own complexity, capability etc. Therefore, the performance and reliability of channel status information (CSI) need not be same for all computing devices (104). Hence, the base station (104) may apply some filter before accepting the channel status information (CSI) report from different computing devices (102). The base station (104) may categorize the computing devices (102) based on the reliability of channel status information (CSI).

The categorization can use some of the following methods such as Rank, Layer Indicator and Precoder validity ((RI) and Type I/Type II precoding matrix indicator (PMI) vs sounding reference signal (SRS) channel). In time division duplication (TDD) systems, the downlink (DL) channel matrix can be made available at the base station (104) medium access control (MAC) scheduler using the uplink sounding reference signal (UL SRS) channel estimation. The rank, layer indicator and precoder can be estimated at the base station (104) using the channel. The channel state information (CSI) reliability can be computed by comparing the estimated channel state information (CSI) with the channel status information (CSI) feedback.

In an exemplary implementation, a channel quality information (CQI) reliability may be ensured using the block error rate (BLER) and signal to interference plus noise ratio (SINR) offset from outer loop link adaptation (OLLA). A rank fallback can be obtained when the computing devices (102) estimate the rank indicator (RI) and channel quality information (CQI) based on the downlink (DL) channel conditions and reports based on the CSI reporting configuration. The base station (104) can adjust the CSI based on the history of information to meet various requirements (For e.g, reliability). Hence, the base station (104) can schedule the computing devices (104) with the computing devices (104) having lower number of layers than the reported RI (>1) based on the Rank reliability and buffer occupancy status. For e.g., If high priority computing devices (102) need more reliability than the data rate, base station (104) can fallback the rank which can ensure more reliability.

In an exemplary embodiment, the (DM-RS) in new radio (NR) provides quite some flexibility to cater for different deployment scenarios and use cases: a front-loaded design to enable low latency, support for up to 12 orthogonal antenna ports for multiple input multiple output (MIMO), transmissions durations from 2 to 14 symbols, and up to four reference-signal instances per slot to support very high-speed scenarios. Mapping Type A and B: The DM-RS location is fixed to 3rd or 4th in mapping type A. For mapping Type B, the DM-RS location is fixed to the 1st symbol of the allocated physical downlink shared channel (PDSCH). From the Phy-Parameters Common in PDSCH-Config, the scheduler/system (300) reads the mapping type and applies the corresponding field in the PDSCH. The mapping type for PDSCH transmission is dynamically signalled as part of the downlink control information (DCI).

In an exemplary implementation, time domain allocations for demodulation reference signal (DM-RS) include both single-symbol and double-symbol DM-RS. The time-domain location of DM-RS depends on the scheduled data duration. Multiple orthogonal reference signals can be created in each DM-RS occasion. The different reference signals are separated in the frequency and code domains, and, in the case of a double-symbol DM-RS, additionally in the time domain. Two different types of demodulation reference signals (DM-RS) can be configured such as the Type 1 and type 2, differing in the mapping in the frequency domain and the maximum number of orthogonal reference signals. Type 1 can provide up to four orthogonal signals using a single-symbol DM-RS and up to eight orthogonal reference signals using a double-symbol DM-RS. The corresponding numbers for type 2 are six and twelve. The reference signal structure to use is determined based on a combination of dynamic scheduling and higher-layer configuration. If a double-symbol reference signal is configured, the scheduling decision, conveyed to the device using the downlink control information, indicates to the device whether to use single-symbol or double-symbol reference signals. The scheduling decision also contains information for the device which reference signals (more specifically, which cloud data management (CDM) groups) that are intended for other devices.

In an exemplary implementation, the physical downlink control channel downlink (PDCCH DCI) formats may include downlink L1/L2 control signalling. It may further consist of downlink scheduling assignments, including information required for the device to properly receive, demodulate, and decode the downlink shared channel (DL-SCH) on a component carrier, and uplink scheduling grants informing the device about the resources and format to use for uplink shared channel (UL-SCH) transmission. In NR, the physical downlink control channel (PDCCH) is used for transmission of control information. The payload transmitted on a PDCCH is known as downlink control Information (DCI) to which a 24-bit (CRC) cyclic redundancy check is attached to detect transmission errors and to aid the decoder in the receiver. Downlink scheduling assignments use DCI format 1-1, the non-fallback format, or DCI format 1-0, also known as fallback format. The non-fallback format 1-1 supports all new radio (NR) features. Depending on the features configured in the system, some information fields may or may not be present. DCI size for format 1-1 depends on the overall configuration. The fallback format 1-0 is smaller in size and supports a limited set of NR functionality.
K₀: Information of the time offset from the slot in which downlink control information (DCI) is received to the slot in which PDSCH is received. Provides the minimum time at which the PDSCH can be transmitted and should be considered in the scheduling algorithm while scheduling the UEs with delay constraints.
K₁: Time offset from physical downlink shared channel (PDSCH) transmission to acknowledgement/negative acknowledgement (ACK/NACK) on physical uplink control channel (PUCCH)
K₂: Time offset from DCI transmission to PUSCH transmission

In an exemplary implementation, the primary focus is DCI Format 1_0 and the UE shall receive the scheduling grant based on that. Therefore, downlink resource allocation type 1 is used where the resource block assignment information indicates to a scheduled UE a set of contiguously allocated non-interleaved or interleaved virtual resource blocks within the active bandwidth part of size N_{BWP}^{size}. Downlink resource allocation field consists of a resource indicator value (RIV) corresponding to a starting virtual resource block (RBₛₜₐᵣₜ) and a length in terms of contiguously allocated resource blocks L_{RBs}. The RIV is defined by,

$$if ( {L}_{RBs} - 1 ) \leq ⌊ {N}_{BWP}^{size} / 2 ⌋ then$$

$$RIV = {N}_{BWP}^{size} ( {L}_{RBs} - 1 ) + {RB}_{start}$$

$$else$$

$$RIV = {N}_{BWP}^{size} ( {N}_{BWP}^{size} - {L}_{RBs} + 1 ) + ( {N}_{BWP}^{size} - 1 - {RB}_{start} )$$

where L_{Rbs}≥1 and shall not exceed N_{BWP}^{size}-RBₛₜₐᵣₜ.

The following information is transmitted by means of the DCI Format 1_0 with cyclic redundancy check (CRC) scrambled by the cell radio network temporary identifier (C-RNTI) OR modulation and coding scheme (MCS) cell radio network temporary identifier (C-RNTI):
a) Identifier for DCI formats-1 bit
   i) The value of this bit field is always set to 1 indicating a DL DCI format/DL,BWP
a) Frequency domain resource assignment −┌log₂(N_{RB}^{DL,BWP}*(N_{RB}^{DL,BWP}+1))┐
   i) N_{RB}^{DL,BWP} is the size of the active DL bandwidth part in case DCI format 1_0 is monitored in the UE specific search space and satisfying
      (1) The total number of different DCI sizes configured to monitor is no more than 4 for the cell, and
      (2) The total number of different DCI sizes with C-RNTI configured to monitor is no more than 3 for the cell,
      (3) otherwise, N_{RB}^{DL,BWP} is the size of CORESET 0.
b) If the cyclic redundancy check (CRC) of the DCI format 1_0 is scrambled by C-RNTI and the “Frequency domain resource assignment” field are of all ones, the DCI format 1_0 is for random access procedure initiated by a PDCCH order, with all remaining fields set as follows:
   i) Random Access Preamble index-6 bits according to ra-Preamble Index. uplink/supplementary uplink (UL/SUL) indicator-1 bit.
      (1) If the value of the “Random Access Preamble index” is not all zeros and if the UE is configured with SUL in the cell, this field indicates which uplink (UL) carrier in the cell to transmit the physical random access channel (PRACH); otherwise, this field is reserved.
      (2) SS/PBCH index-6 bits. If the value of the “Random Access Preamble index” is not all zeros, this field indicates the SS/PBCH that shall be used to determine the random access channel (RACH) occasion for the PRACH transmission; otherwise, this field is reserved.
      (3) PRACH Mask index-4 bits. If the value of the “Random Access Preamble index” is not all zeros, this field indicates the RACH occasion associated with the synchronizing signal/physical broadcasting channel (SS/PBCH) indicated by “SS/PBCH index” for the physical random access channel (PRACH) transmission; otherwise, this field is reserved.
      (4) Reserved-10 bits,
c) Time domain resource assignment-4 bits
d) Virtual resource block to physical resource block (VRB-to-PRB) mapping-1 bit
e) Modulation and coding scheme-5 bits
f) New data indicator-1 bit
g) Redundancy version-2 bits
h) Hybrid automatic repeat request (HARQ) process number-4 bits
i) Downlink assignment index-2 bits, as counter downlink assignment index (DAI)
j) Transmit power control (TPC) command for scheduled physical uplink control channel (PUCCH)-2 bits
k) PUCCH resource indicator-3 bits
l) PDSCH-to-HARQ feedback timing indicator-3 bits

In an exemplary implementation, similar fields are present for DCI format 1_0 scrambled by random access-radio network temporary identifier (RA-RNTI), temporary cell-radio network temporary identifier (TC-RNTI).

To determine the modulation order, target code rate, and transport block sizes in the physical downlink shared channel (PDSCH), the computing devices (102) shall first read,
a. I_{MCS} in the DCI determines the modulation order (Qₘ) and target code rate (R)
b. Redundancy version field (rv) in the DCI determines the redundancy version.
c. The computing devices (102) shall use the number of layers (v) and the total number of allocated physical resource blocks (PRBs) before rate matching (n_{PRB}) to determine the transport block size (TBS) size.
   Modulation and coding scheme (MCS-table) given by PDSCH-Config can be ‘qam256’, ‘qam64LowSE’, or Table 5.1.1 in 38.214.

In an exemplary implementation, physical downlink shared channel-acknowledgement-negative acknowledgement (PDSCH-ACK/NACK) timing defines the time gap between PDSCH transmission and the reception of the performance uplink control channel (PUCCH) that carries ACK/NACK for the PDSCH. The PDSCH-to-HARQ feedback timing is determined as per following procedure and the required information is provided in the DCI.
The 3-bit HARQ timing field in the DCI used to control the transmission timing of the acknowledgement in the UL. Index into an RRC-configured table providing information on when the hybrid-ARQ acknowledgement should be transmitted relative to the reception of the PDSCH.
For DCI Format 1_0, the field maps to {1, 2, 3, 4, 5, 6, 7, 8}
dl-DataToUL-ACK: Provides the mapping from the field to values for a set of number of slots.

For PDSCH reception in slot n as well for SPS through PDCCH reception in slot n, UE provides HARQ transmission within slot n+k, where k is #of slots indicated by PDSCH-to-HARQ timing-indicator field in the DCI format or by dl-DataToUL-ACK. PUSCH-Time Domain Allocation is also provided in the DCI formats 1_0 and 1_1 providing information about the physical uplink shared channel (PUSCH) time domain allocation. K2 specifies an index in the table specified in RRC parameter PUSCH-Time Domain Resource Allocation. In summary,
K₀: Information of the time offset from the slot in which DCI is received to the slot in which physical downlink shared channel (PDSCH) is received. Provides the minimum time at which the PDSCH can be transmitted and should be considered in the scheduling algorithm while scheduling the UEs with delay constraints.
K₁: Time offset from PDSCH transmission to acknowledgement/negative acknowledgement (ACK/NACK) on physical uplink control channel (PUCCH).
K₂: Time offset from downlink control information (DCI) transmission to physical uplink shared channel (PUSCH) transmission.

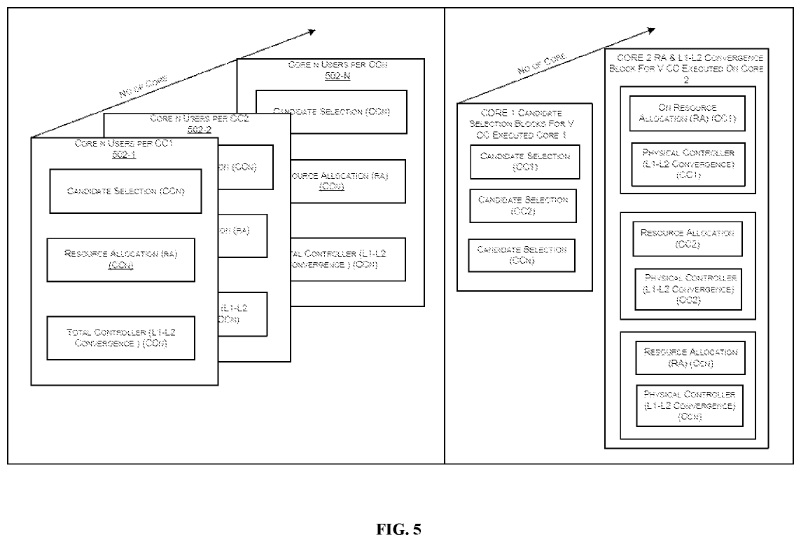

FIG. 5 illustrates an exemplary representation (500) of scalability of the solution for macro and small cell deployment, in accordance with an embodiment of the present disclosure. The proposed system is designed for a macro scale deployment and with the ability to collapse the functional blocks on to minimal number of cores (502-1, 502-2 . . . 502-n) to accommodate small-cell deployment hardware requirements as illustrated in FIG. 4. Features are developed in a modular fashion, such that features are enabled or disabled through a configuration setting. Multi-dimension scalability is considered for the quality of service (QoS)-scheduler.

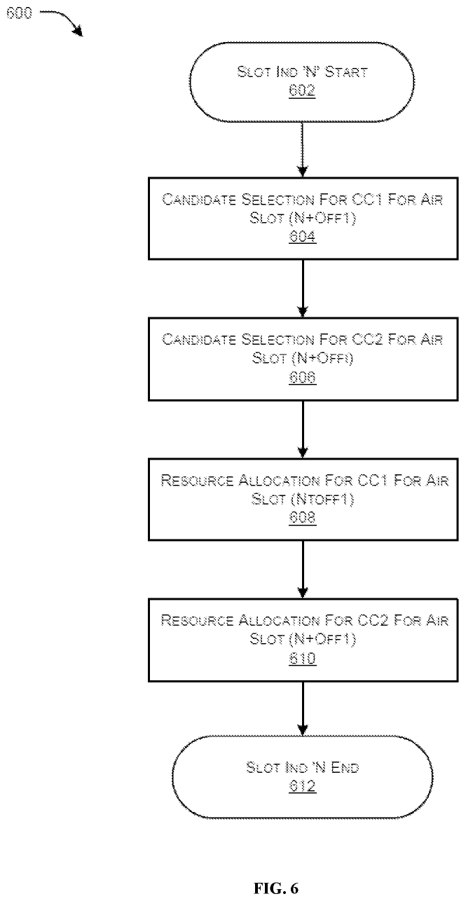

FIG. 6 illustrates a flow diagram (600) of the resource allocation procedure, in accordance with an embodiment of the present disclosure. As illustrated, the flow diagram includes at (602) the step of slot indication “n”. At (604), the flow diagram includes the step of candidate Selection for CC1 for Air Slot (n+off1) and at (606) candidate Selection for CC2 for Air Slot (n+off1). At (608), the flow diagram includes the step of Resource Allocation for CC1 for Air Slot (n+off1) and at (610) Resource Allocation for CC2 for Air Slot (n+off1). At (612), the flow diagram for the slot stops.

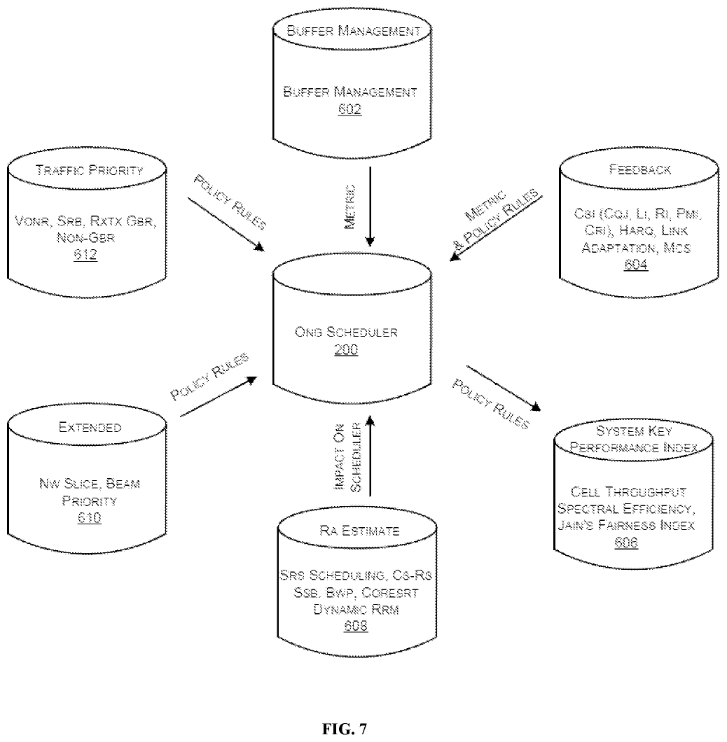

FIG. 7 illustrates a flow diagram (700) of the proposed method, in accordance with an embodiment of the present disclosure. As illustrated, in an embodiment, the method may include the steps of buffer management (702), feedback (704), system key performance index (706), RA estimate (708), extended priority (710), traffic priority (712) coupled to the system (300) and their scheduling can be based on multiple policy rules considering the candidate selection and resource allocation. The policy rules can be enumerated as below:

In an embodiment, the processor (202) may be configured with a cell throughput optimization, a delay sensitivity, a fairness and a minimization of packet drop as the one or more logical parameters.

Policy Rule 1: System dependent variables are considered that are determined by the operator. The variables considered are:
i. Cell throughput optimization: Control parameter α
ii. Delay sensitivity: Control parameter β
iii. Fairness with respect to resource allocation γ
iv. Minimization of Packet Drop δ

In an embodiment, the processor (202) may be configured to categorize the one or more quality of service (QOS) parameters into a guaranteed bit flow rate (GFBR) and a maximum flow bit rate (MFBR). The processor (202) may also classify the one or more computing devices (102) into a guaranteed bit rate (GBR), a delay-critical guaranteed bit rate (GBR), and a non-guaranteed bit rate (non-GBR) applications.

In an embodiment, the one or more policies adapted by the processor (202) may comprise prioritization of a voice over new radio (VoNR) and the guaranteed bit rate (GBR) over the non-guaranteed bit rate (non-GBR) applications associated with the one or more computing devices (102).

Policy rule 2: The resource management module (RRM) provides information about the number of computing devices (102) that can be scheduled per transmission time interval (TTI). RRM also provides information about number of Voice over new radio (NR) (VoNR) applications scheduled per TTI and the number of other guaranteed bit rate (GBR) Traffic/TTI. Policy rule 2 determines the scheduler preference to VoNR and other GBR over non-guaranteed bit rate (non-GBR) flows.

In an embodiment, the one or more policies adapted by the processor (202) may comprise estimation of the one or more resource blocks and a number of layers associated with the one or more computing devices (102) based on the received one or more feedback signals.

Policy rule 3: Resource Block estimation and number of layers to be scheduled per UE are performed based on the channel quality information/precoding matrix indicator/rank indicator (CQI/PMI/RI) feedback obtained from the computing devices (102). For instance, voice over-new radio (VoNR) with its current CQI may require iphysical resource blocks (PRBs), conversational voice may require j RBs and the like. Based on the resource estimation and the number of computing devices (102) per transmission time interval (TTI), the sorted list will be determined based on Policy Rule 4. An estimate of the number of resource blocks (RBs) is determined based on the CQI value from the computing devices (102) and the number of RBs is reduced by the estimated amount for retransmissions and VoNR applications. The remaining RBs are distributed among guaranteed bit rare (GBR) and non-guaranteed bit rate (Non-GBR) traffic based on their respective weight metrics for scheduling. The pseudo code of the algorithm is given below.

### Procedure Initialiation and Priority Order

### I←#of Users

### S←#of Slots

R←#of RBs available for PDSCH
ResourceTypeᵢ ∈{GBR, Non-GBR}, ∀i, i=1,2, . . . I
PDBᵢ, LCᵢ, ∀i
Nu←#ofuserstobescheduled
Handle for DRX and Measurement and users to active&inactive list
Handle refresh period for a set of UEs
LC Prioritization order: SRBs, GBR-VoNR, Other GBR Traffic, Non-GBR
Estimate of total PRBs based on buffer occupancy (BO) of UEs per LC prio. order
Priority 1: DL retranmission schedling
Nᵣₑₜₓ←#ofretransmissionusers (conservativerefertosection 1.x)
for each re-transmission user i do
RBᵣₑₜₓⁱ←ALLOCATION (RBᵣₑₜₓ, R)
if R-RBᵣₑₜₓⁱ==0 then
Resource-Allocation (R, Restransmission Users)
Nᵣₑₜₓ←Nᵣₑₜₓ−1
N_{U}←N_{U}−Nᵣₑₜₓ
end f or
Priority 2: VoNR
for each VoNR i do
N_{VoNR}←#of VONR users
RB_{VoNR}ⁱ←#of RBs for VONR user i
RB_{VoNR}^{i(α)}←ALLOCATION (RB_{VoNR}, R)
N_{VoNR}←N_{VoNR}−1
if R−RB_{VoNR}^{(α)}==0 then
N_{U}←Nᵤ−N_{VoNR}
end f or
Priority 3: [GBR]←METERIC SCHEDULING (Nᵤ, S, cᵢ, dᵢ, qᵢ)
Priority 4: [Non-GBR]←METERIC SCHEDULING (Nᵤ, S, cᵢ, dᵢ, qᵢ)
Candidate←Selected Users from Prioity 1-4
Resource-ALLOCATION (R, Candidates, cᵢ, rᵢ)
∀Users TBS (N_{RE}, MCS, ModulationOrder, nRB)
DCI
Schedule PDCCH-PDSCH
function ALLOCATION (RBs, R)
if RBₐ≥R then
return R
else
Return RBₐ
function DCI
Prepare DCI using steps in HLD
Function METRIC-SCHEDULING (N_{U}, S, cᵢ, dᵢ, qᵢ)
Schedule GBR—NonGBR users to be served in current slot based on the cᵢ, dᵢ and qᵢ
   Uᵢ (cᵢ, dᵢ, qᵢ), ∀i
   ←Utility function for user i with average throughput cᵢ, delay dᵢ, length qᵢ and pdpᵢ
For each application Uᵢ (·) defined accordingly
∇Uᵢ (·)<-gradient of Uᵢ (·)
f(·)←Exponentional function of PDBᵢ
Determine qᵢ based on packets received from RLC
Get HARQ ACK-NACK, CQI-PMI-RI
Determine cᵢ (·) and #of layers
   Every P_{obs}, obtain deviations of received services to update scheduling parameters
Prioritize GBR and Non-GBR
Calculate Nᵤ based on k∈αᵢ ∇Uᵢ (cᵢ, qᵢ dᵢ)rᵢ(s)
General Scheduling rule based on the polices & the untily function
Return GBR & Non-GBR users in determined k
function Resource-Allocation (R, Candidates, cᵢ, rᵢ)
for r=1 to R do
Select u* with hightest metric:

$${u}^{*} = {arg max}_{i ∈ {N}_{u}} HighestMetric$$

Calculate cᵢ (r+1) as cᵢ (r+1)←(1−β) cᵢ (r)+βrᵢ (r)
function TBS (N_{RE}, MCS, ModulationOrder, N_{RB})
Determine TBS based on procedure in HLD

In an embodiment, the one or more policies adapted by the processor (202) comprises prioritization of one or more re-transmissions, the voice over new radio (VoNR), the guaranteed bit rate (GBR) traffic apart from the voice over new radio (VoNR) and the non-guaranteed bit rate (non-GBR) in an increasing order.

Policy rule 4: The applications and the users are prioritized to determine the order in which the applications/users are to be served. Strict priority order is followed.
Retransmissions.
Voice over NR (VoNR) and signalling radio bearers (SRBs).
Guaranteed bit rate (GBR) traffic apart from VoNR.
Non-guaranteed bit rate (Non-GBR) traffic

Within each traffic application, candidate selection is based on the metric calculated from the utility functions corresponding to each of the applications exp. The 1^{st} priority is for retransmissions followed by voice over new radio (VoNR) and signalling radio bearer (SRBs) applications. For guaranteed bit rate (GBR) applications whose packet delay budget (PDB) will be violated if not scheduled in the current transmission time interval per slot (TTI/slot) is given the highest priority in the current scheduling instant. The algorithm to determine the priority of the computing devices (102) follows the below steps. The computing devices (102) can contend for the scheduling opportunity in multiple traffic categories. This ensures ‘NO’ piggyback of the rest of the traffic category. Example: if one computing device (102) out of the computing devices (102) is scheduled for voice over new radio (VoNR) traffic category, the non-guaranteed bit rate (non-GBR) traffic of that computing device (102) is not allowed to be scheduled unless that computing device (102) has contended/won against other computing devices (102) for the non-GBR traffic category. Rough estimate of total physical resource blocks (PRB's) is based on the buffer occupancy of the scheduled locations (LC's) of the computing device (102). A sorted candidate list for each of the traffic category specified above while providing further consideration for ReTx users
For downlink (DL), estimate the block error rate (BLER) for the modulation and coding scheme (MCS) and the latest channel quality indicator (CQI).
For uplink (UL), estimate the block error rate (BLER) for the MCS and the post-equalization SINR.
Allocate the required number of RBs to meet the target BLER

In an embodiment, the one or more policies adapted by the processor (202) comprises application of one or more resource management formulations for sorting the GBR and the non-GBR applications.

Policy rule 5: Each sorted list is based on a utility function. For instance, packet flow switches (PFS) with PDP (packet delay budget) is considered for sorting guaranteed bit rate (GBR) and non-guaranteed bit rate (non-GBR) candidates. Resource management problems are usually formulated in mathematical expressions. The problems then take the form of constrained optimizations: a predetermined objective is optimized under constraints dictating the feasibility of the solution. Formulation of resource management should reflect the policies of the service provider. The formulation may take different forms depending on the resource management policies and each problem may be solved by a unique method. The objective to maximize is a capacity-related performance metric, such as the total throughput and the number of admitted users and the cost to be minimized is the amount of the resources to be consumed in supporting the service quality. As an objective in the resource management problem, the system capacity itself is an important performance metric from the network operator's viewpoint but it is not directly related to the quality of service (QOS) that each individual user would like to get. In order to fill in this gap, many researches have employed the concept of utility which quantifies the satisfaction of each user out of the amount of the allocated resources, thereby transforming the objective to the maximization of the sum of all users' utility. The utility function is determined differently depending on the characteristics of the application.

In an embodiment, the one or more policies adapted by the processor (202) comprises a maximization of the one or more resource blocks.

Policy rule 6: Buffer occupancy and optimal resource block (RB) allocation is another important aspect of ONG-scheduler. Upon noticing that the above polices does not fully ensure maximum RB allocation. ONG-scheduler strategy allows a second level iteration that ensures candidate selection which maximizes RB allocation. These selections are prioritized by the candidates with maximum buffer occupancy. To maximize resource block (RB) utilization has been a unique feature in ONG-scheduler. Underutilized resource blocks (RBs) will not only degrade the cell throughput but also significantly contribute to the increase in buffer occupancy of other users.

A common scenario is when there are many candidates with low data rate and high priority (IMS) in the system. Since users are usually scheduled on LCH priority and with users per transmission time interval (users/TTI) being the constraint. The number of resource blocks (RBs) required to serve these users are significantly lower resulting in underutilized RBs.

The ONG-scheduler handles these users by limiting on how many such users are scheduled in a slot. This is done by distributing low data rate and high priority users among the scheduling slots in such a way that we meet the delay constraints of these applications and allowing other users with larger buffer occupancy to be scheduled in that slot i.e. the remaining RBs are allocated to the users who can maximize the slot ‘RB utilization’.

$${User}_{i} ∈ arg {max}_{1 \leq i \leq N} ( \frac{{RB}_{i}}{{RB}_{total}} )$$

In an embodiment, the one or more policies adapted by the processor (202) may comprise a penalty based non-GBR allocation for the maximization of the one or more resource blocks.

Policy rule 7: To ensure quality of service (QOS) of non-guaranteed bit rate (non-GBR) applications, a penalty based (non-GBR) allocation may be introduced. Within a transmission time interval (TTI), a penalty based (non-GBR) selection to provide fairness, that is, a penalty +1 for non-allocation of Non-GBR candidate in a TTI and a penalty of −1 if Non-GBR candidate is scheduled for that TTI. Now, if the penalty exceeds a certain threshold value (nonGbrₜₕᵣₑₛₕ), the following logic is applied. If optimal RB allocation is not-achieved for the TTI candidates from considering Rxtx, VoNR, GBR list, then we propose a SWAP of GBR candidates with non-GBR.

### Procedure Initialization and Non-GBR Penalty

I←#of Users
R←#of RBs available for PDSCH
Penalty_nongbr=0←#Initialization Penalty Counter
ResourceType_i∈{GBR, Non-GBR}, ∀i, i=1, 2, . . . . I
If Any NonGBR Candidates Scheduled in Current Slot
Increment Penalty_nongbr by m
else
Decrement Penalty_nongbr by n
endIf
If Penalty_nonGBR>Penalty_nonGBRthresh
Allocated Non-GBR candidates for the slot
Considered BO to maximize RB allocation
Reset Penalty_nonGBR to 0
end if

In an embodiment, the one or more policies adapted by the processor (202) may comprise one or more key performance indicators (KPI's) such as a throughput, a cell edge throughput, a fairness index; and optimization of the scheduling priority for the one or more computing devices (102) to achieve the one or more key performance indicators (KPI's).

Policy rule 8: In order to maintain system key performance indicators (KPIs) set by the operator, the concept of opportunistic puncturing of the slots has been introduced to schedule users specifically to cater to the system KPIs.

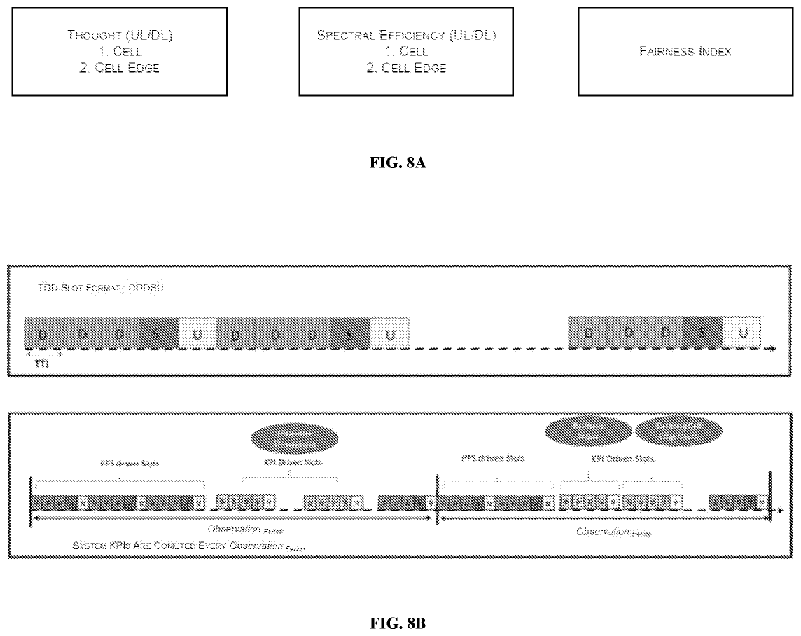

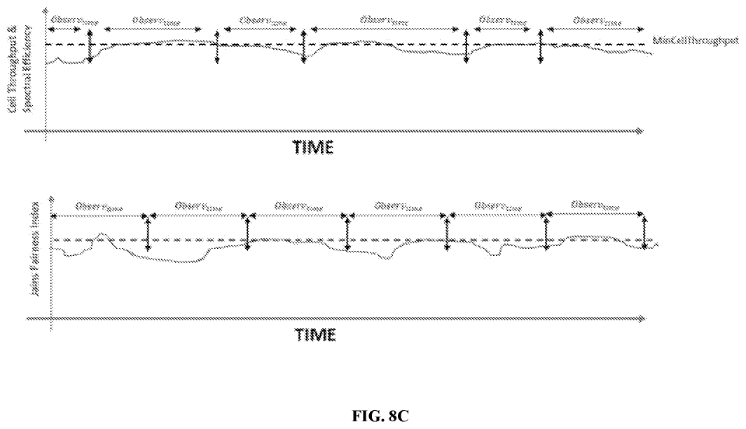

FIGS. 8A-8C illustrate exemplary representations (800) of the proposed quality of service (QOS) scheduler, in accordance with an embodiment of the present disclosure. As illustrated in FIG. 8A throughput required to achieve the required cell throughput set by the operator is shown. The users can be scheduled which would boast the overall system throughput, i.e. the best channel quality information (CQI) users are scheduled, which ensures high throughput.

FIG. 8B illustrates throughput (cell edge) required to achieve the required cell-edge spectral efficiency. The cell-edge users (both GBR and non-GBR) are selected apart from the above set of users to achieve the required throughput (cell edge). FIG. 8C illustrates a Jain's Fairness Index to enable fairness among users. The fairness index is calculated and kept track of among all users. Subsequently puncturing is used to achieve the fairness index (Jain's Fairness Index).

In an exemplary implementation, a procedure for initialization and key performance indicator (KPI) driven scheduler is given below
1. I←#of Users
2. S←#current slot
3. Observₜᵢₘₑ←#observation period
4. Define Scheduler Strategy for KPIₛₗₒₜₛ
5. Over a Observation period Compute KPI_{Throughput}, KPI_{CellEdgeThroughput}, KPI_{jainsfairnessIndex}
6. Estimate the number of slots required for puncturing and distribute these slots for improving
7. Cell Throughput, _{C}ell Edge Throughput & Jain's fairness Index
8. If Currentₛₗₒₜ Punctured
9. Switch for {Cell Throughput, _{Cell Edge Throughput, Fairness Index}}
10. Case Cell Throughput:
11. if (KPI_{Throughput}<SysKPI_{Throughput})
12. UseBestCQIScheduler( ); % Schedule users with CQI>x;
13. end
14. Case Cell Edge Throughput:
15. if (KPI_{CellEdgeThroughput}<SysKPI_{CellEdgeThroughput})
16. ScheduleCellEdgeUsers( ); % Schedule Cell Edge Users
17. end
18. Case Jain's Fairness Index
19. if (KPI_{CellEdgeThroughput}<SysKPI_{CellEdgeThroughput})
20. ScheduleCellEdgeUsers( ); % Schedule Cell Edge Users
21. end

In an exemplary implementation, TABLE 3 shows scheduler strategy

TABLE 3
Scheduler Strategy

| KPI Driven Scheduler | Scheduler Strategy |
|---|---|
| Default | Enhance PF Scheduler |
| Voice over new radio (VoNR) | RR Scheduler |
| Guaranteed bit rate (GBR)/non- | Enhance PF Scheduler |
| guaranteed bit rate(non-GBR) & | |
| non-GBR Puncturing | |
| KPI Puncturing (Cell Throughput | Max. Throughput Scheduler |
| Max.) | |
| KPI Puncturing (Fairness Index) | Schedule Users who improve Jain's |
| | Fairness Index |
| KPI Puncturing Cell Edge | Schedule Cell Edge Users |
| Throughput Max.) | |

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

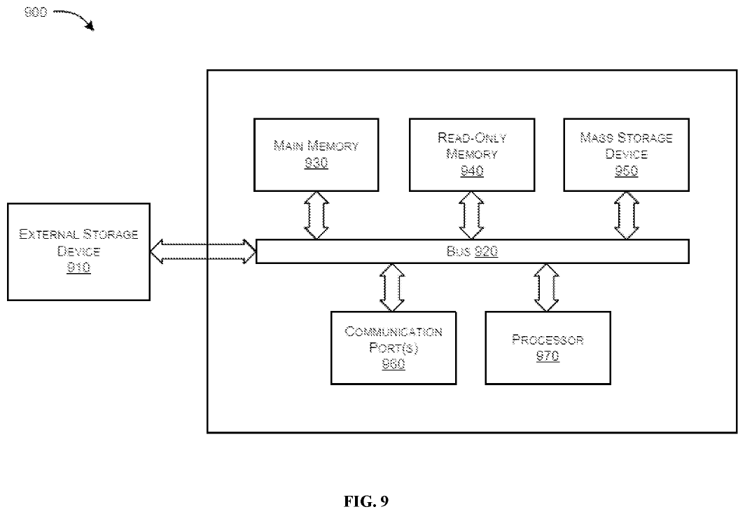

FIG. 9 illustrates an exemplary computer system (900) that can be utilized in accordance with embodiments of the present disclosure. The computer system (900) can include an external storage device (910), a bus (920), a main memory (930), a read only memory (940), a mass storage device (950), communication port (960), and a processor (970). A person skilled in the art will appreciate that the computer system may include more than one processor and communication ports. Processor (970) may include various modules associated with embodiments of the present invention. Communication port (960) can be any of an RS-232 port for use with a modem based dialup connection, a 10/100 Ethernet port, a Gigabit or 10 Gigabit port using copper or fiber, a serial port, a parallel port, or other existing or future ports. Communication port (960) may be chosen depending on a network, such a Local Area Network (LAN), Wide Area Network (WAN), or any network to which computer system connects. Memory (930) can be Random Access Memory (RAM), or any other dynamic storage device commonly known in the art. Read-only memory (940) can be any static storage device(s) e.g., but not limited to, a Programmable Read Only Memory (PROM) chips for storing static information e.g., start-up or basic input/output system (BIOS) instructions for processor (970). Mass storage (950) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7102 family) or Hitachi (e.g., the Hitachi Deskstar 6K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus (920) communicatively couples processor(s) (970) with the other memory, storage and communication blocks. Bus (920) can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor (970) to software system.

Optionally, operator and administrative interfaces, e.g. a display, keyboard, joystick and a cursor control device, may also be coupled to bus (920) to support direct operator interaction with a computer system. Other operator and administrative interfaces can be provided through network connections connected through communication port (960). Components described above are meant only to exemplify various possibilities. In no way should the aforementioned exemplary computer system limit the scope of the present disclosure.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

### Advantages of the Present Disclosure

The present disclosure provides a system and a method that considers multiple system level parameters (e.g., connected users, system KPIs, Feedbacks) along with estimated user channel condition distribution in order to determine users for the DL/UL transmission.

The present disclosure provides a system and a method that computes the resource estimation for each user through a policy resource block allocation.

The present disclosure provides a system and a method that considers system KPIs such as throughput, spectral efficiency, and fairness index.

The present disclosure provides a system and a method that is scalable for multiple cell deployment i.e., macro to small cell deployment.

We claim:

1. A communication system (100) for facilitating improved quality of service by a scheduler, said system comprising:
one or more computing devices (102) configured in the communication system (100) and communicatively coupled to a base station (104) in the communication system (100), wherein the base station (104) is configured to transmit information from a data network (120) configured in the communication system (100);
wherein the base station includes one or more processors (202), coupled to a memory (204) with instructions, when executed causes the processor (202) to:
transmit, one or more primary signals to the one or more computing devices (102), wherein the one or more primary signals are indicative of a channel status information from the base station (104);
receive, one or more feedback signals from the one or more computing devices (102) based on the one or more primary signals, wherein the one or more feedback signals are indicative of one or more parameters associated with the one or more computing devices (102);
extract, a first set of attributes from the received one or more feedback signals, wherein the first set of attributes are indicative of a channel quality indicator (CQI) received from the one or more computing devices (102);
extract, a second set of attributes from the received one or more primary signals, wherein the second set of attributes are indicative of one or more logical parameters of the processor (202);
extract, a third set of attributes, based on the second set of attributes, wherein the third set of attributes are indicative of one or more policies adapted by the processor (202) for scheduling the one or more computing devices (102);
based on the first set of attributes, the second set of attributes and the third set of attributes, generate a scheduling priority for the one or more computing devices (102) using one or more techniques;
transmit, a downlink control information (DCI) to each of the one or more computing devices (102) using one or more resource blocks; and
allocate, the scheduling priority to the one or more computing devices (102) using the one or more resource blocks containing the downlink control information (DCI).

2. The communication system as claimed in claim 1, wherein the one or more parameters comprise a rank, a layer indicator and a precoder validity received from the one or more computing devices (102).

3. The communication system as claimed in claim 1, wherein the one or more techniques comprise any or a combination of a proportional fair (PF), a modified largest weighted delay (M-LWDF), an exp rule, and a log rule.

4. The communication system as claimed in claim 1, wherein the processor (202) is configured: to use one or more formats associated with the downlink control information (DCI) and generate one or more time offsets during the allocation of the scheduling priority.

5. The communication system as claimed in claim 1, wherein the processor (202) is configured: with a cell throughput optimization, a delay sensitivity, a fairness and a minimization of packet drop as the one or more logical parameters.

6. The communication system as claimed in claim 1, wherein the processor (202) is further configured to: generate one or more quality of service (QOS) parameters based on the one or more logical parameters.

7. The communication system as claimed in claim 6, wherein the processor (202) is further configured to: prioritize the one or more computing devices (102) using the one or more quality of service (QOS) parameters while generating the scheduling priority for the one or more computing devices (102).

8. The communication system as claimed in claim 6, wherein the processor (202) is further configured to: categorize the one or more quality of service (QOS) parameters into a guaranteed bit flow rate (GFBR) and a maximum flow bit rate (MFBR); and classify the one or more computing devices (102) into a guaranteed bit rate (GBR), a delay-critical guaranteed bit rate (GBR), and a non-guaranteed bit rate (non-GBR) applications.

9. The communication system as claimed in claim 1, wherein the one or more policies adapted by the processor (202) comprises prioritization of a voice over new radio (VoNR) and the guaranteed bit rate (GBR) over the non-guaranteed bit rate (non-GBR) applications associated with the one or more computing devices (102).

10. The communication system as claimed in claim 1, wherein the one or more policies adapted by the processor (202) comprises estimation of the one or more resource blocks and a number of layers associated with the one or more computing devices (102) based on the received one or more feedback signals.

11. The communication system as claimed in claim 8, wherein the one or more policies adapted by the processor (202) comprises prioritization of one or more re-transmissions, the voice over new radio (VoNR), the guaranteed bit rate (GBR) traffic apart from the voice over new radio (VoNR) and the non-guaranteed bit rate (non-GBR) in an increasing order.

12. The communication system as claimed in claim 8, wherein the one or more policies adapted by the processor (202) comprises application of one or more resource management formulations for sorting the GBR and the non-GBR applications.

13. The communication system as claimed in claim 1, wherein the one or more policies adapted by the processor (202) comprises a maximization of the one or more resource blocks.

14. The communication system as claimed in claim 13, wherein the one or more policies adapted by the processor (202) comprises a penalty based non-GBR allocation for the maximization of the one or more resource blocks.

15. The communication system as claimed in claim 1, wherein the one or more policies adapted by the processor (202) comprises one or more key performance indicators (KPI's) such as a throughput, a cell edge throughput, a fairness index; and optimization of the scheduling priority for the one or more computing devices (102) to achieve the one or more key performance indicators (KPI's).

16. A method (1000) for facilitating improved quality of service by a scheduler, the method comprising:
transmitting, by a processor (202), one or more primary signals to one or more computing devices (102), wherein the one or more primary signals are indicative of a channel status information from the base station (104), and wherein the one or more computing devices (102) are configured in a communication system (100) and communicatively coupled to the base station (104) and wherein the base station (104) is configured to transmit information from a data network;
receiving, by the processor (202), one or more feedback signals from the one or more computing devices (102) based on the one or more primary signals, wherein the one or more feedback signals are indicative of one or more parameters associated with the one or more computing devices (102);
extracting by the processor (202), a first set of attributes from the received one or more feedback signals, wherein the first set of attributes are indicative of a channel quality indicator (CQI) received from the one or more computing devices (102);
extracting by the processor (202), a second set of attributes from the received one or more primary signals, wherein the second set of attributes are indicative of one or more logical parameters of the processor (202);
extracting, by the processor (202), a third set of attributes, based on the second set of attributes, wherein the third set of attributes are indicative of one or more policies adapted by the processor (202) for scheduling the one or more computing devices (102);
generating, by the processor (202), based on the first set of attributes, the second set of attributes and the third set of attributes, a scheduling priority for the one or more computing devices (102) using one or more techniques;
transmitting, by the processor (202), a downlink control information (DCI) to each of the one or more computing devices (102) using one or more resource blocks; and
allocating, by the processor (202), the scheduling priority to the one or more computing devices (102) using the one or more resource blocks containing the downlink control information (DCI).

17. A user equipment (UE) (122) for facilitating improved quality of service in a scheduler, said UE comprising:
one or more processors (216) communicatively coupled to a processor (202) comprised in a communication system (100), the one or more processors (216) coupled with a memory (218), wherein said memory (218) stores instructions which when executed by the one or more processors (820) causes the user equipment (UE) (122) to:
receive, one or more primary signals from the processor (202) wherein the one or more primary signals are indicative of a channel status information from the base station (104);
transmit, one or more feedback signals based on the one or more primary signals, wherein the one or more feedback signals are indicative of one or more parameters from the processor (216), wherein the processor (202) is configured to:
transmit, one or more primary signals to the one or more computing devices (102), wherein the one or more primary signals are indicative of the channel status information from the base station (104);
receive, one or more feedback signals from the one or more computing devices (102) based on the one or more primary signals, wherein the one or more feedback signals are indicative of one or more parameters associated with the one or more computing devices (102);
extract, a first set of attributes from the received one or more feedback signals, wherein the first set of attributes are indicative of a channel quality indicator (CQI) received from the one or more computing devices (102);
extract, a second set of attributes from the received one or more primary signals, wherein the second set of attributes are indicative of one or more logical parameters of the processor (202);
extract, a third set of attributes, based on the second set of attributes, wherein the third set of attributes are indicative of one or more policies adapted by the processor (202) for scheduling the one or more computing devices (102);
based on the first set of attributes, the second set of attributes and the third set of attributes, generate a scheduling priority for the one or more computing devices (102) using one or more techniques;
transmit, a downlink control information (DCI) to each of the one or more computing devices (102) using one or more resource blocks; and
allocate, the scheduling priority to the one or more computing devices (102) using the one or more resource blocks containing the downlink control information (DCI).
